(19) United States
(12) Patent Application Publication
(10) Pub. No.: US 2023/0110799 A1
(43) Pub. Date: Apr. 13, 2023

(54) SYSTEM AND METHOD FOR BILL PAYMENT FROM BILLING OR PAYROLL SYSTEM

(71) Applicant: AISE LLC, Clawson, MI (US)

(72) Inventor: Patrick Tully, Clawson, MI (US)

(21) Appl. No.: 18/081,220

(22) Filed: Dec. 14, 2022

Related U.S. Application Data
(63) Continuation-in-part of application No. 17/524,089, filed on Nov. 11, 2021.
(60) Provisional application No. 63/115,265, filed on Nov. 18, 2020.

(51) Int. Cl. G06Q 20/10; G06Q 20/14; G06Q 20/08; G06Q 40/12

(52) U.S. Cl. CPC G06Q 20/102; G06Q 20/14; G06Q 20/0855; G06Q 40/125

(57) ABSTRACT

This disclosure relates to a system and method for bill payment from a billing or payroll system. In particular, this disclosure enables individuals, such as retirees or employees, to effectively pay their bills directly from their retirement community's billing system or their employer's payroll system, respectively, which has a number of benefits including providing retirees/employees with a convenient system for automating bill payments, and providing the retirees/employees a clearer understanding of their discretionary income and, in turn, providing retirees/employees with benefits to their overall physical and mental health. This disclosure also provides increased certainty to third party billers, knowing their bills will be paid from a relatively secure source, namely the retirement community's billing system or the employer's payroll system.

### RELATED APPLICATIONS

This disclosure is a continuation-in-part of U.S. application Ser. No. 17/524,089, filed Nov. 11, 2021, which claims the benefit of U.S. Provisional Application No. 63/115,265, filed Nov. 18, 2020. The '089 and '265 Applications are herein incorporated by reference in their entirety.

### TECHNICAL FIELD

This disclosure relates to a system and method for bill payment from a billing or a payroll system.

### BACKGROUND

Payroll plays a major role in the operations of an organization. From the perspective of the organization, a payroll is a list of the employees of the organization entitled to receive pay as well as other benefits during a payroll period. From the perspective of the employees, payroll is often their sole or significant source of income. Employees are paid via the payroll system of an organization via a paycheck after each payroll period. Employees have become accustomed in recent years to receiving electronic paychecks, which are often accompanied by an electronic paystub. In such systems, the employee's paycheck is directly deposited into their bank account(s) of choice, and the electronic paystub is provided to the employee. The electronic paystub provides notice to the employee of the electronic deposit amount as well as any deductions for taxes, healthcare, retirement, etc., that occurred during the payroll period. Employees have grown increasingly accustomed to the automated nature of current payroll systems.

### SUMMARY

In some aspects, the techniques described herein relate to a method, including: paying a bill owed by an individual to a third party biller using a payroll or billing system of an organization by first directing funds from the payroll or billing system to a secondary account of the individual and then directing funds from the secondary account to the third party biller.

In some aspects, the techniques described herein relate to a method, wherein the individual is a retiree.

In some aspects, the techniques described herein relate to a method, wherein the organization is a retirement community.

In some aspects, the techniques described herein relate to a method, wherein the payroll or billing system is a billing system of the retirement community.

In some aspects, the techniques described herein relate to a method, wherein the paying step includes paying a plurality of bills of the retiree from the billing system of the retirement community.

In some aspects, the techniques described herein relate to a method, further including: permitting the retiree or an authorized agent of the retiree to select when the paying step occurs within a period of time, and wherein the paying step occurs at a time corresponding to the selection of the retiree or the authorized agent.

In some aspects, the techniques described herein relate to a method, wherein the secondary account is used solely for completing the paying step and is not a primary account of the retiree.

In some aspects, the techniques described herein relate to a method, further including, using a neural network, suggesting that the retiree pay another bill using the payroll system.

In some aspects, the techniques described herein relate to a method, wherein the payroll or billing system communicates with a software application configured to at least partially perform the paying step.

In some aspects, the techniques described herein relate to a method, wherein the software application is a plug-in for payroll or billing software.

In some aspects, the techniques described herein relate to a method, wherein the third party biller is a personal savings account of the individual.

In some aspects, the techniques described herein relate to a method, further including providing the individual with a reward for completing the paying step.

In some aspects, the techniques described herein relate to a method, wherein the reward is interest accumulated in the secondary account.

In some aspects, the techniques described herein relate to a method, wherein: the bill is owed by a first individual and a second individual to the third party biller, first funds are directed from the payroll or billing system to the secondary account on behalf of the first individual, second funds are directed from the payroll or billing system to the secondary account on behalf of the second individual, and the combined first and second funds are directed from the secondary account to the third party biller.

In some aspects, the techniques described herein relate to a method, further including using a neural network to issue a warning to the individual if the individual is seeking to pay a bill that, in the determination of the neural network, will have an adverse influence on the physical, mental, or financial health of the individual.

In some aspects, the techniques described herein relate to a method, further including anonymously comparing the individual to similarly-situated users and disclosing the results of the comparison to the individual.

In some aspects, the techniques described herein relate to a method, wherein the secondary account is requested to be created by a software application when the individual initially begins using the payroll or billing system to pay third party bills.

In some aspects, the techniques described herein relate to a system, including: an application configured to run on a computing device and configured to cause the computing device to direct funds from a payroll or billing system of an organization to pay a bill of an individual owed to a third party, wherein the funds are directed to the third party via a secondary account of the individual.

In some aspects, the techniques described herein relate to a system, wherein the individual is a retiree.

In some aspects, the techniques described herein relate to a system, wherein the organization is a retirement community.

### BRIEF DESCRIPTION OF THE DRAWINGS

FIG. 1 is a highly schematic view of an example system according to this disclosure.

FIG. 2 is schematic representation of an example relationship between an existing payroll system, an application, employees, and billers.

FIG. 3 is an example interface of the application.

FIG. 4 is another example interface of the application.

FIG. 5 is a schematic representation of an example relationship between an existing billing system, an application, retirees (or their agents), and billers.

### DETAILED DESCRIPTION

This disclosure relates to a system and method for bill payment from a billing or payroll system. In particular, this disclosure enables individuals, such as retirees or employees, to effectively pay their bills directly from their retirement community's billing system or their employer's payroll system, respectively, which has a number of benefits including providing retirees/employees with a convenient system for automating bill payments, and providing the retirees/employees a clearer understanding of their discretionary income and, in turn, providing retirees/employees with benefits to their overall physical and mental health. This disclosure also provides increased certainty to third party billers, knowing their bills will be paid from a relatively secure source, namely the retirement community's billing system or the employer's payroll system.

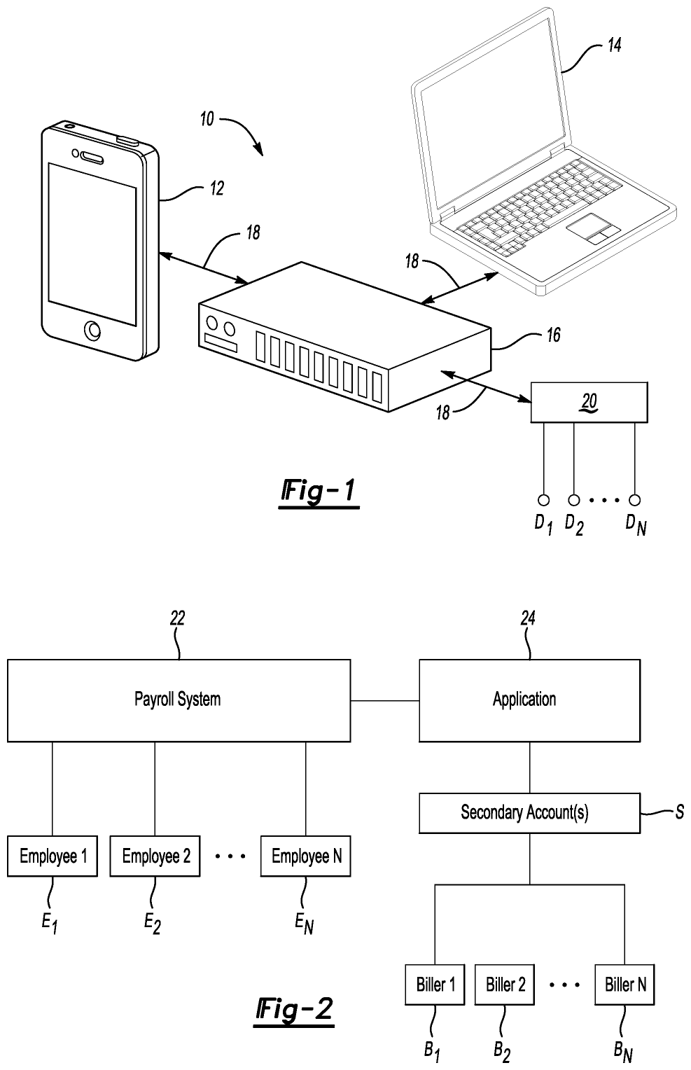

FIG. 1 is a highly schematic view of an example system 10 for paying bills from a payroll system. In this example, the system 10 includes a first computing device 12, a second computing device 14, and a third computing device 16. As shown in FIG. 1, the first computing device 12 is a mobile computing device, such as a tablet or a smartphone. The second computing device 14 is a laptop or desktop computer, and the third computing device 16 is a computing device including a server. Relative to the third computing device 16 in particular, while shown as a single server, the third computing device 16 can be implemented using multiple components at various locations. The first, second, and third computing devices 12, 14, 16 are illustrated for purposes of explanation, and should not be considered as limiting regarding the type or number of computing devices used with the disclosed system 10.

In this example, the first, second, and third computing devices 12, 14, 16 are in communication with one other as schematically shown via connections 18, which include wireless links and/or hard-wired connections, such as those used to access the Internet. Each of the first, second, and third computing devices 12, 14, 16 may include memory, hardware, and software, and be configured to communicate with one another and transmit data between one another. The first, second, and third computing devices 12, 14, 16 may further be configured to store information and data, and send and receive instructions to one another to execute the methodology and techniques described below.

The system 10 may also include an artificial neural network 20 (“neural network 20”) incorporated into or interfaced with the system 10. Alternatively or in addition, the neural network 20 may be embodied in whole or in part on a cloud based service. The neural network 20 is configured to receive and process a plurality of different types of data D₁-D_{N}, where “N” represents any number. The neural network 20 may be a deep generative neural network, which is alternatively referred to as a flow model neural network. The neural network 20 provides a framework for machine learning. Specifically, in one example, the neural network 20 is trained to predict how various data inputs (i.e., from the data D₁-D_{N}) relate to whether an employee should incur a new financial obligation. Other example uses for the neural network 20 are described below. A neural network 20 is not required in all examples.

FIG. 2 schematically illustrates an example relationship between a payroll system 22 of an organization, employees E₁-E_{N} of the organization, and third-party billers B₁-B_{N}. Relative to the employees E₁-E_{N} and billers B₁-E_{N}, “N” represents any number. Further, the term “organization” in this disclosure refers to entities such as companies, institutions, and associations. Employees refer to those individuals that are paid by the payroll system 22 of the organization, whether or not those individuals fit a strict legal definition of an employee. Billers are third parties, not including the organization or the employees, to which the employees may have financial obligations. The payroll system 22 of the organization may include one or more dashboards indicating various metrics pertaining to the employees' E₁-E_{N} usage of third party bill pay through the payroll system 22 and/or the application 24.

In this disclosure, an application 24 is incorporated into, or in communication with, the payroll system 22. The application 24 includes software, and may also include hardware. The payroll system 22 may also include a combination of hardware and software. The application 24 may be considered a software plug-in for the existing software of a payroll system 22. Alternatively, the application 24 is a stand-alone software application. The payroll system 22 and the application 24 may be embodied on and/or accessed by the first, second, and/or third computing devices 12, 14, 16. The application 24 is configured to cause the first, second, and/or third computing devices 12, 14, 16 to perform various methods and strategies, as discussed below.

In some embodiments, employees E₁-E_{N} and billers B₁-B_{N} can access the application 24 directly. In other embodiments, such as when the payroll system 22 incorporates the application 24 as a software plug-in, employees E₁-E_{N} have access to the functionality of the application through their payroll system 22. The employees E₁-E_{N} and billers B₁-B_{N} may see different interfaces when accessing the payroll system 22 and/or the application 24, as certain information may be confidential.

For many if not most employees E₁-E_{N}, the income received through their periodic paychecks represents a significant portion of their income, if not the sole source of their income. Further, employees E₁-E_{N} have become accustomed to not receiving physical paychecks, but instead have grown accustomed to receiving periodic direct deposits into their bank account(s) of choice and receiving a paystub, either physical or virtual, that details the deductions and withholdings for each pay period, such as those for taxes, healthcare, 401(k), etc. In this disclosure, the application 24 permits the employees E₁-E_{N} to choose to pay their bills owed to billers B₁-B_{N} through the payroll system 22. In other words, money owed to billers B₁-B_{N} is effectively paid directly to the billers B1-B_{N} without being first transferred to a primary account of the employees E₁-E_{N}. Rather, the money owed to billers B₁-B_{N} is directed to a secondary account S of the employees E₁-E_{N}, each of which is owned by a respective employee E₁-E_{N}, and money from the secondary account S is directed to the billers B₁-B_{N}. The secondary account S is established solely for paying the billers B₁-B_{N}. The secondary account S is different than a primary account of the employees E₁-E_{N}, which is typically where a majority if not an entirety of the banking of the employees E₁-E_{N} is done. In an example of this disclosure, the sole purpose of the secondary account S is to assist in transferring funds from the payroll system 22 to the billers B₁-B_{N} via the secondary account S. When the employee initially enrolls in the bill pay functionality, the software application 24 requests that a financial institution establish the secondary account S in the name of the employee. The payroll system 22 would inform the employee of the need to establish a secondary account S and seek the consent of the employee in advance of requesting the account to be opened. Once the secondary account S has been created, all bills enrolled in third party bill pay through the payroll system 22 of that employee are paid using the same secondary account S. The payroll system 22 and the software application 24 direct funds to the billers B₁-B_{N} to pay the bills owed by the employees E₁-E_{N} via the secondary accounts S. In this manner, while the secondary accounts S are in the name of the employees E₁-E_{N}, the employees are not required to take any affirmative steps to transfer funds out of the secondary accounts S to the billers B₁-B_{N} to ensure the bills are paid.

While secondary accounts S are mentioned herein, this disclosure extends to other methods of transferring funds from the payroll system 22 to the billers B₁-B_{N}, including directly transferring funds from the payroll system 22 to the billers B₁-B_{N}. Alternatively, some billers B₁-B_{N} may have the option of creating their own page or portal within the application 24 permitting employees E₁-E_{N} to pay the billers directly (without using a secondary account S) via that page/portal, such as by using an electronic payment.

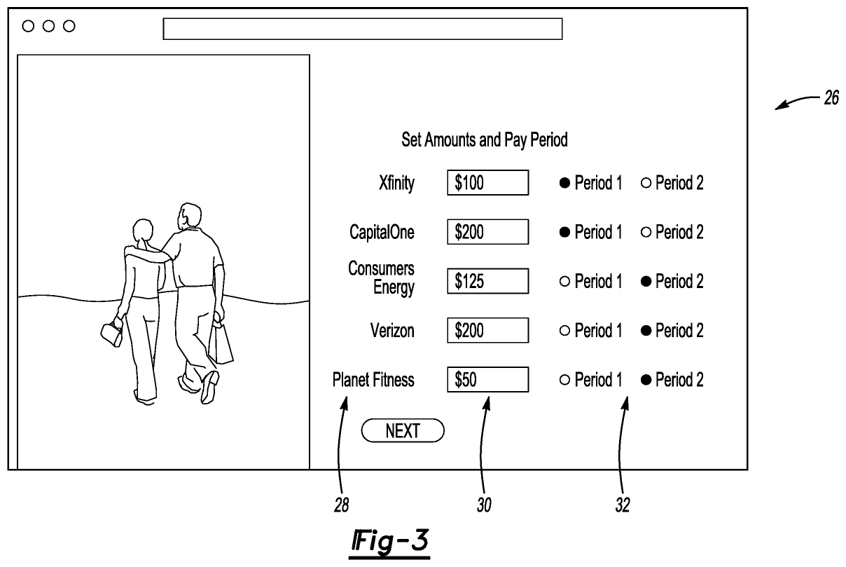

FIG. 3 illustrates an example interface 26 of the application 24 which is presented to employees E₁-E_{N} via the first or second computing device 12, 14. Using the interface 26, an employee (i.e., one of employees E₁-E_{N}) may choose to pay one or more of their bills via the payroll system 22.

The interface 26 includes three columns 28, 30, 32. The first column 28 includes a list of billers B₁-B_{N}. The employee may be able to select from a list of billers B₁-B_{N} that have agreed to permit their bills to be paid via the application 24. In this example, the employee has chosen to have five bills paid via the application 24. The billers B₁-B_{N} are Xfinity, which is an internet and/or cable provider, Capital One, which is a credit card company, Consumers Energy, which is a utilities company, Verizon, which is a cell phone company, and Planet Fitness, which is a gym. These billers B₁-B_{N} are exemplary. The billers B₁-B_{N} may include mortgage companies or creditors.

The second column 30 permits the employee to enter the amount to be paid to the biller B₁-B_{N} via the application 24. As the amount may vary, this amount may be provided periodically, such as every month, to the application 24 by the billers B₁-B_{N}. The amounts may be provided by the billers B₁-B_{N} via an application programming interface (API) link from the billers B₁-B_{N} to the application 24. The API link may automatically pull the bill amounts using personally identifiable information (PII) of the employees E₁-E_{N}. In the third column 32, the employee is able to select which pay period, within a particular month, for example, that they wish to have a particular amount withheld from their paycheck and directed to a particular biller B₁-B_{N}. The employees E₁-E_{N} may also select an option for paying a monthly bill over two pay periods, by making two partial payments per month, if permitted by the billers B₁-B_{N}. In this manner, the employee is able to manage their cashflow by evenly distributing their bill pay or paying them all at one, depending on the preference of the employee. In this example, the employee has chosen to have their Xfinity and Capital One bills paid out of their first paycheck of the month, and while having their bills from Consumers Energy, Verizon, and Planet Fitness, paid out of the second paycheck of the month.

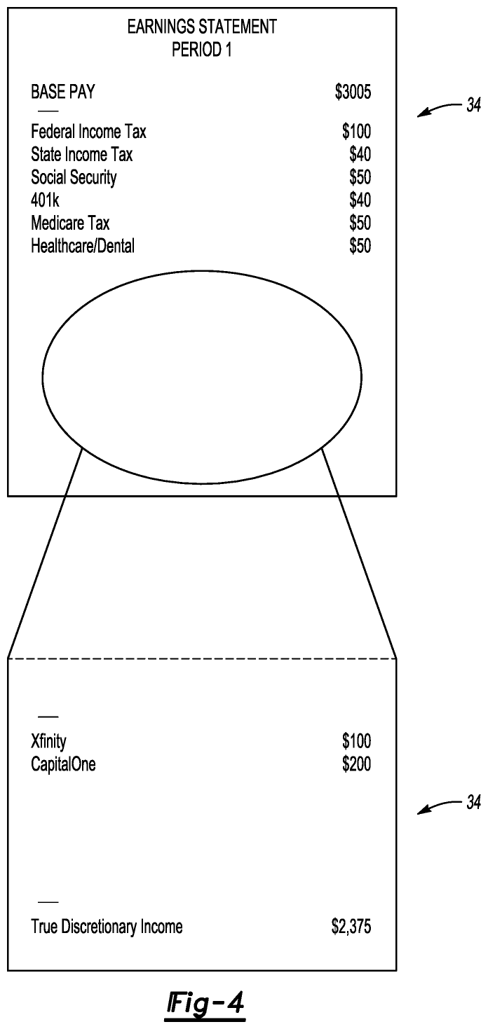

With reference to FIG. 4, another example interface 34 is shown. The example interface 34 is an interface of the application 24 and is presented to an employee via the first or second computing device 12, 14. The example interface 34 is an example paystub for period 1, following the example of FIG. 3. The paystub includes the employee's base pay, which is $3,005 in this example, and traditional withholdings such as taxes, 401(k), and healthcare, etc., which total $330 in this example. The paystub also includes the amounts paid to billers B₁-B_{N} during period 1. Following the example of FIG. 3, bills were paid to Xfinity and Capital One totaling $300. Thus, during period 1 the payroll system 22 paid $2,375 to the employee and transferred $300 to billers Xfinity and Capital One. The interface 34 thus presents to the employee relatively accurate representation of the discretionary income for period 1, which is $2,375. The accuracy of the discretionary income figure increases with a higher percentage of an employee's bills being paid through the application 24.

While not technically a “biller,” one of the billers B₁-B_{N} may be a personal savings account, including an actual savings account, brokerage account, 529 account, etc., of the employee. Thus, by treating personal savings as a “biller,” the employees E₁-E_{N} may use the application 24 to automate savings.

Another aspect of this disclosure includes providing the end users, which here are the employees E₁-E_{N}, with surveys regarding their experiences using the application 24, including surveys designed to determine whether the application 24 has improved their financial, physical, and/or mental health. The neural network 20 may receive and process the feedback from the surveys and recommend updates, upgrades, or changes to the application 24 over time based on the user feedback. The organization may have access to the results of the survey. The neural network 20 may also provide feedback and recommendations to the organization regarding their employees' overall health.

Another aspect of this disclosure includes providing benefits to the end users, who again are the employees E₁-E_{N}, for using the application 24 to pay their bills. Employers have an incentive in providing their employees E₁-E_{N} with such rewards because it improves the financial health of the workforce leading to a more productive workforce, and also helps with retention and recruitment efforts. The benefits could come in the form of monetary and/or non-monetary benefits, including incentives, rewards, etc., from the billers B₁-B_{N}, their employer, and/or the maker of the application 24. Another benefit may be the employers paying a bill for the employees E₁-E_{N} directly or indirectly by providing the employees E₁-E_{N} with funds corresponding to an amount of a bill of the employees E₁-E_{N}, such as by adding those funds to the appropriate secondary account S. The survey may ask end users questions to determine what types of benefits may be attractive to the end users. The neural network 20 may analyze that information and make recommendations to the employers and/or billers B₁-B_{N} to offer additional incentives to either retain users and/or attract new users to the application 24.

From a perspective of the employees E₁-E_{N}, their bills owed to the billers B₁-B_{N} are paid seamlessly with minimal effort on their part. In most cases, the majority if not all of the work involves enrolling in the application 24. One the back end, ensuring funds are transferred in the correct amounts and to the correct billers B₁-B_{N} may include coordination between the human resources department of the organization, the maker of the application 24, an intermediate bank that establishes secondary accounts S for the employees E₁-E_{N}, and the billers B₁-B_{N}. The application 24 may also contract with or use an intermediate bank or other financial institution capable of handling fund transfers. In an example, the application 24 may send files, such as comma-separated value (CSV) files, between the billers B₁-B_{N}, an intermediate bank, and the payroll system 22 including information regarding the bills that need to be paid to each biller B₁-B_{N} by each employee E₁-E_{N}. The application 24 may utilize batch processing to save on transaction costs. For instance, all bills paid by all employees E₁-E_{N} to a particular biller B₁-B_{N} are processed at the same time each month, regardless of when the employees E₁-E_{N} select that bill to be withheld from their paycheck (i.e., regardless of whether the employee selects period 1 or period 2 in FIG. 3).

In another example, a financial institution will be utilized solely for a depository function. In this case, fund transfers and bill payments are coordinated by a billing data provider. In another example, the payroll system 22 may connect using an API in order to have funds withdrawn.

In the example where the maker of the application 24 contracts with an intermediate bank or other financial institution to handle transferring of funds between the payroll system 22 and the billers B₁-B_{N}, the maker of the application 24 may open a bank account with the intermediate bank corresponding to each organization, and may further establish sub-accounts for each employee E₁-E_{N}. As funds are placed in these accounts, if only for a period of time, they may accumulate interest. The interest may be kept by the maker of the application 24 as additional income or transferred to the employees E₁-E_{N} as an incentive for using the application 24.

Another aspect of this disclosure relates to two or more employees E₁-E_{N} combining funds to pay a shared bill. For example, a husband and wife that either both work for the same employer or both work for employers that have payroll systems that subscribe to and/or use the application 24, can combine their funds to a pay a particular bill. For instance, one of the billers B₁-B_{N} may be a mortgage provider that provided a mortgage to the husband and wife. The husband and wife may divide their mortgage payment between them, either split evenly or at a different amounts, as selected by the users. The application 24 may then withhold a portion of the mortgage payment from the husband's paycheck and the remaining portion from the wife's paycheck. The payroll system 22 may then pay the mortgage to the mortgage provider. Again, in an example, the payroll system 22 first routes the funds to a secondary bank account, which may be owned by one or both of the husband and wife, and the funds are then directed to the mortgage company from the secondary bank account. This feature of combining funds to pay a shared bill may be used to pay bills other than a mortgage, and is not limited to use by a husband and wife. This feature may be particularly useful when a shared bill exceeds one employee's base pay for a particular pay period.

Another aspect of the neural network 20 relates to whether the employees E₁-E_{N} should incur additional monthly expenses. The neural network 20 is able to review the base pay and monthly expenses of all users, and the results of the end user surveys, to determine whether incurring another monthly expense will have adverse effects on the employee's physical, mental, or financial health. If the neural network 20 determines it is against an employee's interest to incur another expense, the neural network 20 may issue a warning prompt to the employee via an interface of the application 24. The employee may override the warning in some examples.

The neural network 20 may also suggest that a particular employee enroll certain of the employee's bills to be paid via the application 24 if, for example, the neural network 20 determines that the employee's physical, mental, or financial health would benefit from doing so. Again, this recommendation may be presented to the employee via an interface of the application 24, and the employee may either decide to accept or reject the recommendation of the neural network 20. The neural network 20 may also suggest that the employee use the application 24 to make certain payments for events or changes that may occur later in life, such as saving for purchasing a house, getting married, having a child, or reducing outstanding debt.

The application 24 could also pay billers B₁-B_{N} using a credit card of the employee E₁-E_{N}. In that scenario, the application 24 will still deduct the bill amounts from the employee's paycheck as described above, but will route the funds to the credit card company rather than the biller B₁-B_{N}, thus allowing the user to continue to gain credit card rewards while also ensuring the bills are paid in a timely manner.

In another aspect of this disclosure, employees E₁-E_{N} can compare themselves to other, similarly-situated end-users, including employees E₁-E_{N} or other users. The comparison is anonymized. The comparison may include one or more pieces of data, including the number of bills paid using the system, the amount of bills paid, etc. The comparison may deem users similarly-situated based on one or more of age, income, location, etc. The comparison may be presented on a dashboard visible by only an individual employee. Each employee would have a different dashboard. The dashboard may present information such as annual spend, categories of annual spend, credit score, etc., along with providing comparisons to similarly-situated users as to this information.

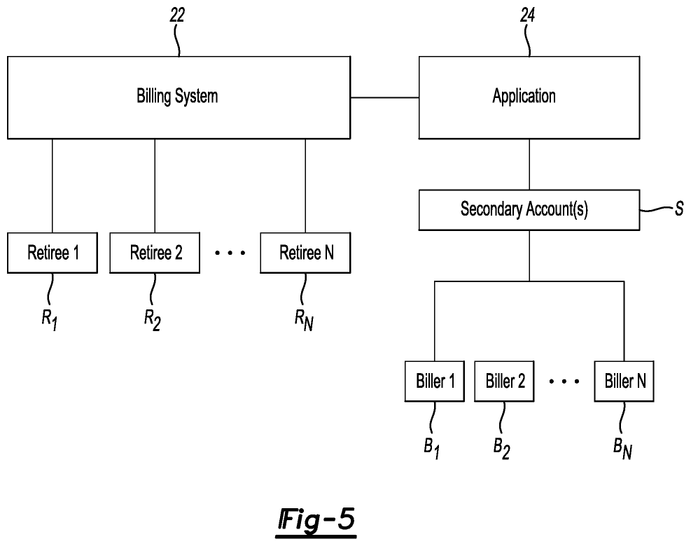

FIG. 5 represents another aspect of this disclosure. In particular, FIG. 5 is a schematic representation of an example relationship between an existing billing system, an application, retirees (or their authorized agents), and billers. The embodiment of FIG. 5 is substantially similar to the above-discussed embodiments, and may include all corresponding features thereof, with the exception that instead of employees, the embodiment of FIG. 5 relates to retirees within a retirement community, and with the additional exception that FIG. 5 relates to a billing system of a retirement community as opposed to an employer's payroll system.

The term retirement community refers to residential community or housing complex designed for older adults. The term retirement community includes nursing homes, assisted living communities, elder care and living or care facilities, complexes, or housing for the underprivileged or disabled, and other similar communities, in this disclosure. The term retiree refers to those individuals that reside within such communities, whether or not those individuals have truly retired from employment.

FIG. 5 schematically illustrates an example relationship between a billing system 22 of a retirement community, retirees R₁-R_{N} of the retirement community, and third-party billers B₁-B_{N}. In this disclosure, the application 24 is incorporated into, or in communication with, the billing system 22 of the retirement community, in the same manner as in the above-discussed embodiments.

In some examples, the retirees R₁-R_{N} and billers B₁-B_{N} can access the application 24 directly. In other embodiments, such as when the billing system 22 incorporates the application 24 as a software plug-in, retirees R₁-R_{N} have access to the functionality of the application 24 through the billing system 22 of the retirement community. Further, authorized agents of the retirees R₁-R_{N} may also have access to the functionality of the application 24, and, once authorized, the agents may be able to use the application 24 to enroll their corresponding retiree(s) in the bill pay functionality provided by the application 24.

In this disclosure, the application 24 permits the retirees R₁-R_{N} to choose to pay their bills owed to billers B₁-B_{N} through the billing system 22. Specifically, the money owed to billers B₁-B_{N} is directed to a secondary account S of the retirees R₁-R_{N}, each of which is owned by a respective retiree R₁-R_{N}, or an authorized agent of the retiree, and money from the secondary account S is directed to the billers B₁-B_{N}. The secondary account S is established solely for paying the billers B₁-B_{N} in one example. In an example of this disclosure, the sole purpose of the secondary account S is to assist in transferring funds from the billing system 22 to the billers B₁-B_{N} via the secondary account S. When the retiree initially enrolls in the bill pay functionality, or their authorized agent enrolls them, the software application 24 requests that a financial institution establish the secondary account S in the name of the retiree. The billing system 22 would inform the retiree, or their agent, of the need to establish a secondary account S and seek the consent of the retiree, or their agent, in advance of requesting the account to be opened. Once the secondary account S has been created, all bills enrolled in third party bill pay through the billing system 22 are paid using the same secondary account S. The billing system 22 and the software application 24 direct funds to the billers B₁-B_{N} to pay the bills owed by the retirees R₁-R_{N} via the secondary accounts S. In this manner, while the secondary accounts S are in the name of the retirees R₁-R_{N}, the retirees are not required to take any affirmative steps to transfer funds out of the secondary accounts S to the billers B₁-B_{N} to ensure the bills are paid. The secondary accounts S may be funded by the retiree or their agent periodically, or funded via periodic payments to the retirement community.

As many retirees find it increasingly difficult to manage their own affairs due to complications with advanced age, such as dementia, etc., this aspect of the disclosure provides a dramatic benefit. Not only are the bills of the retiree conveniently paid automatically using the billing system of the retirement community, but the retirees can be enrolled in the system and have their bills managed by authorized agents of the retirees.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A method, comprising:
paying a bill owed by an individual to a third party biller using a payroll or billing system of an organization by first directing funds from the payroll or billing system to a secondary account of the individual and then directing funds from the secondary account to the third party biller.

2. The method as recited in claim 1, wherein the individual is a retiree.

3. The method as recited in claim 2, wherein the organization is a retirement community.

4. The method as recited in claim 3, wherein the payroll or billing system is a billing system of the retirement community.

5. The method as recited in claim 4, wherein the paying step includes paying a plurality of bills of the retiree from the billing system of the retirement community.

6. The method as recited in claim 2, further comprising:
permitting the retiree or an authorized agent of the retiree to select when the paying step occurs within a period of time, and wherein the paying step occurs at a time corresponding to the selection of the retiree or the authorized agent.

7. The method as recited in claim 2, wherein the secondary account is used solely for completing the paying step and is not a primary account of the retiree.

8. The method as recited in claim 2, further comprising, using a neural network, suggesting that the retiree pay another bill using the payroll system.

9. The method as recited in claim 1, wherein the payroll or billing system communicates with a software application configured to at least partially perform the paying step.

10. The method as recited in claim 9, wherein the software application is a plug-in for payroll or billing software.

11. The method as recited in claim 1, wherein the third party biller is a personal savings account of the individual.

12. The method as recited in claim 1, further comprising providing the individual with a reward for completing the paying step.

13. The method as recited in claim 12, wherein the reward is interest accumulated in the secondary account.

14. The method as recited in claim 1, wherein:
the bill is owed by a first individual and a second individual to the third party biller,
first funds are directed from the payroll or billing system to the secondary account on behalf of the first individual,
second funds are directed from the payroll or billing system to the secondary account on behalf of the second individual, and
the combined first and second funds are directed from the secondary account to the third party biller.

15. The method as recited in claim 1, further comprising using a neural network to issue a warning to the individual if the individual is seeking to pay a bill that, in the determination of the neural network, will have an adverse influence on the physical, mental, or financial health of the individual.

16. The method as recited in claim 1, further comprising anonymously comparing the individual to similarly-situated users and disclosing the results of the comparison to the individual.

17. The method as recited in claim 1, wherein the secondary account is requested to be created by a software application when the individual initially begins using the payroll or billing system to pay third party bills.

18. A system, comprising:
an application configured to run on a computing device and configured to cause the computing device to direct funds from a payroll or billing system of an organization to pay a bill of an individual owed to a third party, wherein the funds are directed to the third party via a secondary account of the individual.

19. The system as recited in claim 18, wherein the individual is a retiree.

20. The system as recited in claim 19, wherein the organization is a retirement community.
